(19) United States
(12) Patent Application Publication
(10) Pub. No.: US 2007/0238356 A1
(43) Pub. Date: Oct. 11, 2007

(54) Connecting element for connection of service switching devices which are arranged parallel to one another

(75) Inventors: Rudolf Sellner, Hockenheim (DE); Matthias Bitz, Leon-Rot (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/727,613

(22) Filed: Mar. 27, 2007

(30) Foreign Application Priority Data
Mar. 29, 2006 (DE) 10 2006 014 445.7
Apr. 27, 2006 (DE) 10 2006 019 577.9

(51) Int. Cl. H01R 13/648

(52) U.S. Cl. 439/607

(57) ABSTRACT

Connecting element for connection of at least two service switching devices, e.g., circuit breakers, residual-current devices, main current switches and the like which are arranged parallel to one another and whose enclosures are formed from enclosure parts, having a sprung cylindrical base body which is in the form of a sleeve and has a circular cross section formed around a centre axis, in which case the base body which is formed with latching means can be inserted into a hole which is formed in the respective enclosure part and can be secured in an interlocking manner in the hole in the enclosure part, in which case the latching means, which can be integrally linked with a uniform material joint to the base body which is formed from a metallic material, can be formed to be autonomously sprung, so that the connecting element has a spring effect which is formed by the sprung base body and the latching means. This can result in a connecting element for connection of at least two service switching devices which, while having a simple design, has a high load capacity and allows at least one further connecting means to be passed through it.

### RELATED APPLICATIONS

This application claims priority under 35 U.S.C. §119 to German Application 10 2006 014 445.7 filed in Germany on Mar. 29, 2006, and to German Application 10 2006 019 577.9 filed in Germany on Apr. 27, 2006, the entire contents of which are hereby incorporated by reference in their entireties.

### TECHNICAL FIELD

A connecting element is disclosed for connection of at least two service switching devices. The disclosure also relates to the connection of at least two service switching devices by means of such connecting elements, and also to the connection of at least two service switching devices to a mount element.

### BACKGROUND INFORMATION

Connecting elements of this generic type are known for the connection of service switching devices and relate in particular to single-pole electrical circuit breakers having an enclosure, with the enclosure being formed from generally two enclosures, which form an internal area. In this case, the end edges of the shell walls are opposite one another, with the two shells being fixed to one another by means, for example, of riveted joints. Single-pole service switching devices such as these can be combined to form multipole service switching devices, in which case the connecting elements of this generic type which are of interest here are used to connect the individual devices to one another.

As an alternative to a riveted joint, EP 1 109 277 A2 describes two service switching devices being connected by means of a connecting element which has an approximately cylindrical base body with a first external diameter, on each of whose end faces two radially sprung-open, axially projecting first and second spreading arms are in each case integrally formed. The outer contours of the spreading arms lie on a cylindrical envelope surface whose external diameter is smaller than the first external diameter of the base body. The free ends of the spreading arms have radially projecting tabs, to be precise on opposite envelope lines. In the installed state, the tabs latch behind recesses on the enclosures, which are to be connected to the connecting element, of the service switching devices which are located alongside one another.

DE 20 2004 013 708 U1 discloses a connecting element for two service switching devices which are arranged in a row alongside one another with their broad faces resting on one another and, in particular, are circuit breakers or residual current devices whose enclosures are each formed from two shell-like enclosure parts. The connecting element has an approximately cylindrical base body with a first external diameter, on each of whose end faces two radially springing-open, axially projecting, first and second spreading arms are in each case integrally formed, whose outer contours lie on a cylindrical envelope surface. The external diameters are in this case smaller than the first external diameter of the base body, with their free ends having radially projecting tabs on opposite envelope lines. In the installed state, these latch behind recesses on the enclosures, which are to be connected to the connecting element, of the service switching devices which are located alongside one another, with in each case one spacer being fitted at least to a first or second spreading arm, and with the height of the spacer defining the minimum distance to which the first and second spreading arms can be pressed towards one another.

DE 79 00 929 discloses a switching device whose enclosure is connected to an additional device with the aid of snap-action, attachment and clamping means, and/or whose enclosure shells are held together by means such as these, with the devices being connected by rivet-like latching elements which pass through holes, which are provided with flat recesses, and have spreading heads which latch in the flat recesses.

One problem that occurs with the known connecting elements is that they are produced by injection moulding and are formed from a plastic material which does not allow the connecting elements to absorb high loads, because of its comparatively low strength. These plastic connections can easily break, in which case there is likewise a risk of the latching means being deformed in the event of a relatively high load, making the connecting elements unusable. Furthermore, repeated release and latching in of the latching means again leads to wear, likewise leading to the connecting elements becoming unusable.

Furthermore, the known connecting elements have no continuous core holes for screws, riveted joints or other bolt-like elements to pass through, which may be required in order, for example, to link further devices by means of the elements in the form of bolts, in which case these can be passed through the connecting elements themselves. This is prevented by internal spacers, which represent an interruption in the continuous core hole.

### SUMMARY

An exemplary connecting element is disclosed for connection of at least two service switching devices, in which the stated disadvantages are avoided, in particular with a connecting element being provided which has a high load capacity, with a simple design. For example, an exemplary connecting element is disclosed for connection of at least two service switching devices, e.g., circuit breakers, residual-current devices, main current switches and the like which are arranged parallel to one another and whose enclosures are formed from enclosure parts, having a sprung cylindrical base body which is in the form of a sleeve and has a circular cross section formed around a centre axis, in which case the base body which is formed with latching means can be inserted into a hole which is formed in the respective enclosure part and can be secured in an interlocking manner in the hole in the enclosure part.

An improved exemplary connection is also disclosed for at least two service switching devices, both to one another and to a mount element. For example, an exemplary connection is disclosed of at least two service switching devices by means of such connecting elements, and also to the connection of at least two service switching devices to a mount element.

Exemplary latching means, which are integrally linked with a uniform material joint to the base body which is formed from a metallic material, can be configured to be autonomously sprung, so that the connecting element has a spring effect which is formed by the sprung base body and the latching means.

The specific exemplary embodiment of the joint spring effect is made possible by the use of a metallic material which has a high strength, in order to allow the connecting element to have a correspondingly high load capacity. Owing to the extended elastic area of the metallic material, the base body is itself sprung, so that, when the connecting element is inserted into the hole in the enclosure of the service switching device, it is sufficiently highly flexible and the latching means themselves can likewise spring in with respect to the base body, thus making it possible to increase the overall flexibility as a result of the addition of the individual flexible areas. This makes it possible to use a material with a greater thickness, thus further increasing the strength.

In this case, the base body advantageously has a core hole which can be formed along the centre axis, so that an element in the form of a bolt can be passed through the core hole. The provision of a continuous core hole is made possible by the base body being formed from a spring sheet which can be bent in the form of a sleeve, with the latching means being unlatched outwards in the radial direction from the spring sheet by forming. This results in a connecting element which not only has high stiffness but also allows the connection of the service switching devices to have a high load capacity, in which case it is nevertheless possible to provide a core hole through which an element in the form of a bolt, such as a screw, can be passed in order to screw a further additional device to an adjacent service switching device.

The use of a spring sheet which is bent into the form of a sleeve makes it possible to produce the base body by means of separating and forming methods, in which case at least the contour of the spring sheet, comprising the spring slots as well as the latching means, is produced by a shearing cut, and the collars as well as the latching means can be formed by means of upsetting and bending processes. Spring sheet steel can be used as the basic material, and is first of all stamped out in the unwound contour of the connecting element that is in the form of a sleeve. Once the internal closed contours have been stamped out, such as those of the latching means, the outer contour can be stamped. A bending method can then be used in order to produce the bent contour of the latching means. This step can be carried out before or after the bending process to bend the flat sheet-metal material into the form of a sleeve.

An exemplary base body can have a centre plane which is arranged at right angles to the centre axis, with the base body extending symmetrically towards both sides of the centre plane. The connecting element can thus be configured to be symmetrical overall, with the cylindrical base body extending essentially with radial symmetry around the centre axis, and being symmetrical on both sides of the centre plane. The centre axis is at right angles to the centre plane, with the centre plane at the same time being located on the separating plane between the two devices when the connecting element is inserted in the two service switching devices.

A further exemplary embodiment provides for the base body to have collars which can be formed adjacent to the centre plane, on both sides of it. The collars run radially symmetrically circumferentially in the form of outward bulges which can be formed radially outwards. The collars can be produced as upset areas in the sheet-metal material of the connecting element, which is in the form of a sleeve, with the upsetting being carried out from the direction of the centre axis, thus resulting in the collar having an annular contour which points outwards. When the connecting element is inserted into the enclosure of the service switching device, the collar forms a stop, so that the connecting element can be inserted only to a predetermined depth into the hole in the enclosure. When the second enclosure is being joined to the connecting element, this makes it possible to prevent this from entering further into the hole in the first connecting element.

According to a further exemplary embodiment, the base body can be bounded in the direction of the centre axis by in each case one free end in the longitudinal direction, and has spring slots which extend from the respective free end in the base body in the direction of the respective collar. Furthermore, the base body has a longitudinal slot, which extends parallel towards the centre axis over the entire length of the base body. The slotted shape of the base body which is in the form of a sleeve makes it possible to achieve the spring effect that is desired from it and which assists the spring effect of the latching means during insertion into the holes in the enclosure halves of the service switching devices.

If the base body is inserted into the hole along the centre axis in the direction of the respective side, the hole has approximately the same diameter as the base body, which the connecting element has when no force is applied. The fact that the latching means are bent radially outwards means that the base body must be compressed radially, during the joining process, by an amount which corresponds to the difference in the diameter between the hole in the enclosure and the external diameter of the latching means. The longitudinal slot which extends parallel towards the centre axis over the entire length of the base body results in the radially symmetrical cross section being interrupted in one area, thus resulting in the base body having a C-shaped cross section. This allows the base body to be deformed more easily in the radial direction pointing inwards, since the stiffness of the base body is considerably reduced by the elongated-slotted shape. This makes it easier to insert the connecting element into the hole, without any significant adverse affect on the overall load capacity of the connection. The spring slots which extend from the respective free ends in the base body in the direction of the collars additionally support the spring effect. The spring slots can be formed sufficiently deeply into the base body that areas of the base body which can be sprung inwards are created, in which the latching means can be arranged.

The latching means can each be arranged offset through approximately 90° with respect to the longitudinal slot and with respect to the spring slot on the circumference of the base body. Two latching means can be formed on each side of the centre plane and arranged offset through 180° with respect to one another on the circumference of the base body. This makes it possible to provide a total of 4 latching means which can be arranged symmetrically on both sides of the centre plane and are each opposite one another in pairs. With an angle offset of 90°, the latching means are opposite the spring slot as well as the longitudinal slot, so that the slot and latching-means arrangement assists the radially inward springing of the area of the base body in which the latching means are in each case arranged.

The base body can have an annular cross section which is interrupted by the longitudinal slot on an angle segment which is related to the centre axis, with the angle of the angle segment being 35° to 55°, e.g., between 40° to 50°, or about 45°.

An improved connection can be achieved for at least two exemplary service switching devices which are arranged parallel to one another and whose enclosures are formed from enclosure parts, by the enclosure being connected by an exemplary connecting element, in which case the connecting element is inserted into a hole which is formed in the respective enclosure part and being secured in an interlocking manner in the hole in the enclosure part, and with a connecting element which at least in places can be in the form of a bolt being passed through the core hole in the connecting element, so that this results in an additional connection between the service switching devices.

An improved connection of at least two service switching devices which are arranged parallel to one another and whose enclosures are formed from enclosure parts, having a mount element, for example an adapter, can be achieved in that the exemplary service switching devices are connected to one another by at least one exemplary connecting element, in which case the connecting element is inserted into a hole, which is formed in the respective enclosure part, and being secured in an interlocking manner in the hole in the enclosure part, and in which case the exemplary service switching devices are connected to the mount element by a connecting element which is passed through the core hole in the connecting element and at least in places can be in the form of a bolt.

The connecting element which is in the form of a bolt can be an elongated screw, by means of which the service switching devices can additionally be screwed to one another and to the mount element.

### BRIEF DESCRIPTION OF THE DRAWINGS

The exemplary embodiments are described in more detail in the following text together with the description of the various exemplary embodiments, on the basis of the figures, in which:

FIG. 1 shows a view of an exemplary connecting element, showing a plan view of an exemplary latching means;

FIG. 2 shows a view of the exemplary connecting element shown in FIG. 1, with the radial position in this view being rotated through 90°, and showing a plan view of the longitudinal slot;

FIG. 3 shows a view of the exemplary connecting element as shown in FIGS. 1 and 2, looking in the direction of the centre axis, and

FIG. 4 shows a view in the form of a partial section through three service switching devices which are connected by exemplary connecting elements and are connected to a mount element by an elongated screw which is passed through the core holes.

### DETAILED DESCRIPTION

The exemplary connecting element 1 illustrated in FIG. 1 is cylindrical and extends along a centre axis 11 in the longitudinal direction. In the longitudinal direction, the exemplary connecting element 1 is bounded by a respective free end 16a and 16b, with the cylindrical external diameter being milled onto the respective free ends 16a, 16b in order to improve the capability to insert the connecting element 1 into the associated hole in the enclosure of the service switching device. The connecting element 1 can be configured to be symmetrical on the left and right-hand sides about the centre plane 14, with the centre axis 11 and the centre plane 14 each being represented by dashed-dotted lines.

The cylindrical shape of the base body 10 which forms the connecting element 1 can be interrupted by two collars 15a and 15b, which point radially outwards as an outward bulge which is formed in the outward direction. The collars 15a and 15b are each located adjacent to the centre plane 14 and run radially symmetrically around the existing cylindrical cross section. The collars 15a and 15b can be used as stops during insertion of the connecting element 1 into the hole in the enclosure of the service switching device, in order to prevent this from being passed too deeply into the hole.

Furthermore, latching means 12a and 12b are provided, with a total of 4 latching means being arranged in a distributed form and each being located one above the other on the left-hand side and on the right-hand side in the plane of the drawing. The latching means 12a and 12b can be formed integrally and with a uniform material joint with the base body 10, and can be cut out of the material of the base body 10 by means of cutouts 19a and 19b.

In order to create an interlocking connection of the connecting element 1 in the hole in the enclosure of the service switching device, the latching means 12a and 12b can be bent radially outwards out of the cylindrical basic structure of the base body 10. The bent-out, lug-like shape of the latching means 12a, 12b points in the direction of the centre plane 14, so that, during the joining of the connecting element 1, the latching means 12a, 12b can be deformed elastically radially inwards, in order to snap back into an undercut in the respective hole in the enclosure in the bent-out position pointing radially outwards.

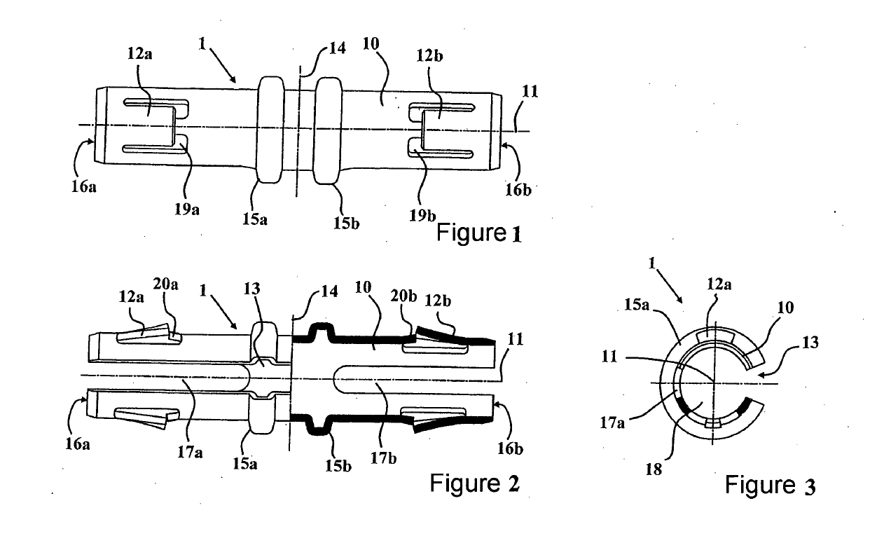

FIG. 2 shows a view of the exemplary connecting element 1 illustrated in a radial position in which a longitudinal slot 13 can be seen in the form of a plan view. The longitudinal slot 13 extends over the entire length of the base body 10 from the first free end 16a, shown on the left-hand side, to the second free end 16b, shown on the right-hand side. The longitudinal slot 13 can be used to increase the flexibility of the base body 10, in order to make it easier to insert the connecting element 1 into a hole, since the flexibility assists the effect of the latching means 12a, 12b springing back in the direction pointing radially inwards. This is based on a reduction in the stiffness of the base body 10, since the C-shape formed by the longitudinal slot 13 is less stiff than a closed circular cross section. Furthermore, the bending operation that is carried out during manufacture can be made easier in order to bend the planar initial material, which is in the form of a metal sheet, into the form of a sleeve, without having to connect the bent edges, which point towards one another, of the sheet-metal material by means of a joining process to form a closed annular cross section.

A plan view of the connecting element 1 is shown on the plane of the drawing on the left-hand side of the centre plane 14, with the connecting element 1 being illustrated in a sectioned form on the right-hand side of the centre plane 14. This shows the contour of the collar 15b, which can be formed with a meandering shape as an upset cylindrical section, pointing radially outwards.

A spring slot 17a and 17b can be respectively formed on the left-hand side and on the right-hand side with an angle offset of 180° with respect to the longitudinal slot 13, extending from the respective free end 16a or 16b approximately to the plane of the respective collar 15a or 15b in the direction of the centre plane 14. The spring slots 17a and 17b can be used to reduce the stiffness of the base body 10, in order to increase the flexibility for the connecting element 1 to spring into the associated hole. This makes it possible for the spring slots 17a, 17b to achieve the same spring effect as that provided by the longitudinal slot 13. The latching means 12a and 12b, respectively, can be formed pointing radially outwards from the side of the respective free end 16a and 16b on the basis of a curvature line, with a tab 20a, 20b, which is likewise bent outwards, being provided at the end of the latching means 12a, 12b, which can be in the form of tongues, and with this tab 20a, 20b respectively being associated with one of the existing latching means 12a, 12b in each case. This can be formed integrally by the specific configuration of the respective cutout 19 on the base body 10, with all of the geometric embodiments being produced by means of stamping and bending operations on the base body 10.

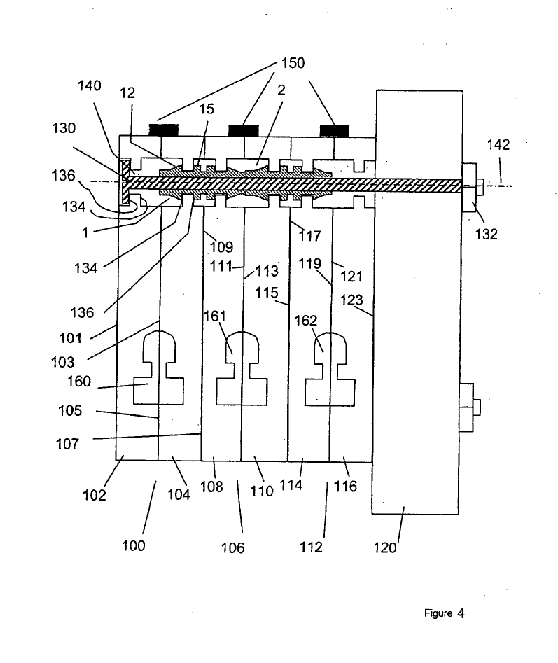

FIG. 3 shows an exemplary base body 10, which forms the exemplary connecting element 1, with its C-shaped footprint, with the longitudinal slot 13 forming the opening area of the circular cross section. The base body 10 in this case has an annular cross section which can be interrupted by the longitudinal slot 13 on an angle segment which is related to the centre axis 11, with the angle of the angle segment being approximately 45°. However, the base body can have an annular cross section which is interrupted by the longitudinal slot on an angle segment which is related to the centre axis, with the angle of the angle segment being 35° to 55°, e.g., between 40° to 50°. The illustration shows the latching means 12a, which likewise has a cross section in the form of part of a circle. The opening of the longitudinal slot 13 extends both over the base body 10 and over the collar 15, with a spring slot 17a being formed opposite the longitudinal slot 13. The C-shaped basic structure of the base body 10 encloses a core hole 18 which can be formed uniformly and continuously over the entire length of the base body 10 and allows at least one further connecting means, which can be in the form of a bolt, to pass through.

FIG. 4 shows, schematically, a view in the form of a partial section through three exemplary service switching devices 100, 106, 112 which are connected by connecting elements 1, 2 and are connected to a mount element 120, in this case an adapter, by means of a longitudinal screw 130 which is passed through the core holes 18.

Each of the exemplary service switching devices 100, 106, 112 has two enclosure parts 102, 104 and 108, 110 as well as 114, 116, respectively, which can be joined together on respective first and second inner broad faces 103, 105 and 111, 113 as well as 119, 121. Their outer broad faces 109, 107 and 115, 117 are parallel to one another. The third switching device 112 can be located with its second outer broad face 123 parallel to the mount element 120, in this case an adapter. The first outer broad face 100 of the first service switching device 100 can be freely accessible.

FIG. 4 shows a view of the upper narrow face of the exemplary service switching devices. This shows the terminal openings 160, 161, 162 and the switching knob 150 on the front face.

The service switching devices 100, 106, 112 have a hole 140 in the vicinity of their front faces. The hole 140 is applied to each service switching device such that it results in a continuous hole with a continuous centre axis 142 when the service switching devices are arranged parallel in a row.

The hole 140 in each enclosure part 102, 104, 108, 110, 114, 116 can be widened on its outer and inner broad faces 101, 103, 105, 107 or 109, 111, 113, 115 or 117, 119, 121, 123, thus in each case resulting in a stop 136 from the direction of the outer broad face 101, 107, 109, 115, 117, 123, and an undercut 134 from the direction of the inner broad faces 103, 105, 111, 113, 119, 121.

An exemplary connecting element 1 can now be inserted into the hole 140 between the first and second service switching devices 100, 106 in such a way that its latching means 12 form an interlocking connection with the undercut 134 and the collar 15 rests on the stop 134, thus preventing the connecting element 1, 2 from being inserted too far into the corresponding hole 140.

The second and third service switching devices 106, 112 can be connected in the same way by a connecting element 2 such as this.

An elongated screw 130 is passed through the continuous core hole 18 and its screw head rests on the stop 136 which can be located close to the first outer broad face 101 of the first service switching device 100. The free end of the elongated screw 130 is passed through a corresponding hole in the mount element 120, and can be screwed by means of a nut 132 to its broad face, which is opposite the second outer broad face 123 of the third service switching device 112. The arrangement of the three switching devices 100, 106, 112 thus in this way not only results in these devices being connected to one another by the two connecting elements 1, 2 but in the pack of switching devices formed in this way being screwed to the mount element 120 by means of the elongated screws 130, in a simple manner. Holes such as those described above, can, of course, be provided at different points in the service switching devices 100, 106, 112, at which the devices can then be connected to one another and/or to a corresponding mount element 120 by means of further connecting elements and, if required, by elongated screws passed through their core holes or else other suitable connecting elements in the form of a bolts.

The advantage of the type of attachment illustrated in FIG. 4 is that the connecting element, in this case the elongated screw 130, can be fitted very easily and, after it has been installed, is largely concealed in the interior of the switching device and thus no longer has any external disturbing effect.

It is, of course, also feasible for the connections of the switching devices to one another only to be reinforced by a connecting element in the form of other bolts, without the arrangement of the switching devices having to be fitted to a mount element. For this purpose, the connecting element 130 in the form of a bolt would be attached on the two outer broad faces 101, 123 which are exposed without a mount element, against the stop 134. This would make it possible to produce additional reinforcements in the connection.

The various exemplary embodiments are not restricted to the exemplary embodiments specified above. In fact, a number of variants are feasible which also make use of the described solution in various types of embodiments. Accordingly, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1, 2 Connecting element
10 Base body
11 Centre axis
12 Latching means
13 Longitudinal slot
14 Centre plane
15 Collar
16 Free end
17 Spring slot
18 Core hole
19 Cutout
20 Tab
100,106,112 Service switching device
101,109,117 First outer broad face
103,111,119 First inner broad face
107,113,121 Second inner broad face
107,115,123 Second outer broad face
102,104,108,
110,114,116 Enclosure parts
120 Mount element
130 Connecting element in the form of a bolt
132 Nut
134 Undercut
136 Stop
140 Hole in the enclosure
142 Centre axis
150 Switching knob
160,161,162 Terminal opening

What is claimed is:

1. Connecting element for connection of at least two service switching devices which are arranged parallel to one another and whose enclosures are formed from enclosure parts, having a sprung cylindrical base body which is in the form of a sleeve and has a circular cross section formed around a centre axis, in which case the base body which is formed with latching means can be inserted into a hole which is formed in the respective enclosure part (and can be secured in an interlocking manner in the hole in the enclosure part, wherein the latching means, which are integrally linked with a uniform material joint to the base body which is formed from a metallic material, are designed to be autonomously sprung, so that the connecting element has a spring effect which is formed by the sprung base body and the latching means.

2. Connecting element according to claim 1, wherein the base body has a centre plane which is arranged at right angles to the centre axis, with the base body extending symmetrically towards both sides of the centre plane.

3. Connecting element according to claim 2, wherein the base body has collars which are formed adjacent to the centre plane, on both sides of it.

4. Connecting element according to claim 1, wherein the base body is bounded in the direction of the centre axis by in each case one free end in the longitudinal direction and has spring slots which extend from the respective free end in the base body in the direction of the respective collar.

5. Connecting element according to claim 1, wherein the base body has a longitudinal slot, which extends parallel towards the centre axis over the entire length of the base body.

6. Connecting element according to claim 5, wherein the spring slots are offset through approximately 180° with respect to the longitudinal slot on the circumference of the base body, in order to reinforce the radial spring effect of the base body.

7. Connecting element according to claim 1, wherein the base body is formed from a spring sheet which is bent in the form of a sleeve, with the latching means being unlatched outwards in the radial direction from the spring sheet.

8. Connecting element according to claim 1, wherein the latching means are arranged offset through approximately 90° with respect to the longitudinal slot on the circumference of the base body.

9. Connecting element according to claim 1, wherein two latching means are in each case formed on each side of the centre plane and are arranged offset through 180° with respect to one another on the circumference of the base body.

10. Connecting element according to claim 1, wherein the base body has an annular cross section which is interrupted by the longitudinal slot on an angle segment which is related to the centre axis, with the angle of the angle segment being between 35° to 55°.

11. Connecting element according to claim 1, wherein the base body has a core hole which is formed along the centre axis, so that an element in the form of a bolt can be passed through the core hole.

12. Connecting element according to claim 1, wherein the base body is produced by means of separating and forming methods, in which case at least the contour of the spring sheet, comprising the spring slots as well as the latching means, is produced by a shearing cut, and the collars as well as the latching means are produced by upsetting and bending methods.

13. Connection of at least two service switching devices which are arranged parallel to one another and whose enclosures are formed from enclosure parts, having a connecting element according to claim 1, in which case the connecting element is inserted into a hole which is formed in the respective enclosure part and being secured in an interlocking manner in the hole in the enclosure part, characterized in that a connecting element which at least in places is in the form of a bolt is passed through the core hole in the connecting element, so as to produce an additional connection between the service switching devices.

14. Connection of at least two service switching devices which are arranged parallel to one another and whose enclosures are formed from enclosure parts, having a mount element, with the service switching devices being connected to one another by at least one connecting element according to claim 1, in which case the connecting element is inserted into a hole, which is formed in the respective enclosure part, and being secured in an interlocking manner in the hole in the enclosure part, characterized in that the service switching devices are connected to the mount element by means of a connecting element which is passed through the core hole in the connecting element and at least in places is in the form of a bolt.

15. Connection according to claim 13, wherein the connecting element which at least in places is in the form of a bolt is an elongated screw.

16. The connecting element according to claim 1 for connection of at least two service switching devices, chosen from the group comprising circuit breakers, residual-current devices and main current switches, which are arranged parallel to one another and whose enclosures are formed from enclosure parts.

17. Connecting element according to claim 3, wherein the base body is bounded in the direction of the centre axis by in each case one free end in the longitudinal direction and has spring slots which extend from the respective free end in the base body in the direction of the respective collar.

18. Connecting element according to claim 4, wherein the base body has a longitudinal slot, which extends parallel towards the centre axis over the entire length of the base body.

19. Connecting element according to claim 6, wherein the base body is formed from a spring sheet which is bent in the form of a sleeve, with the latching means being unlatched outwards in the radial direction from the spring sheet.

20. Connecting element according to claim 7, wherein the latching means are arranged offset through approximately 90° with respect to the longitudinal slot on the circumference of the base body.

21. Connecting element according to claim 8, wherein two latching means are in each case formed on each side of the centre plane and are arranged offset through 180° with respect to one another on the circumference of the base body.

22. Connecting element according to claim 9, wherein the base body has an annular cross section which is interrupted by the longitudinal slot on an angle segment which is related to the centre axis, with the angle of the angle segment being about 45°, or between 40° to 50°.

23. Connecting element according to claim 10, wherein the base body has a core hole which is formed along the centre axis, so that an element in the form of a bolt can be passed through the core hole.

24. Connecting element according to claim 11, wherein the base body is produced by separating and forming methods, in which case at least the contour of the spring sheet, comprising the spring slots as well as the latching means, is produced by a shearing cut, and the collars as well as the latching means are produced by upsetting and bending methods.

25. Connection of at least two service switching devices which are arranged parallel to one another and whose enclosures are formed from enclosure parts, having a connecting element according to claim 12, in which case the connecting element is inserted into a hole which is formed in the respective enclosure part and being secured in an interlocking manner in the hole in the enclosure part, characterized in that a connecting element which at least in places is in the form of a bolt is passed through the core hole in the connecting element, so as to produce an additional connection between the service switching devices.

26. Connection of at least two service switching devices which are arranged parallel to one another and whose enclosures are formed from enclosure parts, having a mount element, with the service switching devices being connected to one another by at least one connecting element according to claim 13, in which case the connecting element is inserted into a hole, which is formed in the respective enclosure part, and being secured in an interlocking manner in the hole in the enclosure part, characterized in that the service switching devices are connected to the mount element by means of a connecting element which is passed through the core hole in the connecting element and at least in places is in the form of a bolt.

27. Connection according to claim 14, wherein the connecting element which at least in places is in the form of a bolt is an elongated screw.

28. A connecting element for connection of at least two service switching devices which are arranged parallel to one another and whose enclosures are formed from enclosure parts, comprising:
a sprung cylindrical base body which is in the form of a sleeve; and
latching means integrally linked with a uniform material joint to the base body which is formed from a metallic material, configured to be autonomously sprung,
wherein the base body with latching means is insertable into a hole which is formed in the respective enclosure part and can be secured in an interlocking manner.
